(19) United States
(12) Patent Application Publication
(10) Pub. No.: US 2009/0021510 A1
(43) Pub. Date: Jan. 22, 2009

(54) DISPLAY

(75) Inventor: Alexander KLINTSTROM, Larbro (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/781,263

(22) Filed: Jul. 22, 2007

(51) Int. Cl. H04B 1/16

(52) U.S. Cl. 345/214; 345/48

(57) ABSTRACT

A portable communication device may include a motion detection unit adapted to measure movement related data, a processing unit adapted to receive the movement related data from the motion detection unit, and at least one light emitting element adapted to receive control signals from the processing unit. The processing unit may be adapted to compute a lighting scheme that determines when to activate and when to deactivate the at least one light emitting element based on said movement related data, and to send control information according to said lighting scheme to the at least one light emitting element for activating and deactivating the at least one light emitting element, such that the at least one light emitting element, when the portable communication device is moved over a region of space, may create an illusive display adapted to convey information using persistence of vision of a viewer.

### TECHNICAL FIELD

Embodiments disclosed herein may relate to the field of portable communication devices. More particularly, embodiments disclosed herein may relate to a device and method for displaying information by means of a portable communication device.

### BACKGROUND

Information that may be displayed to the user of a portable communication device includes an indication of the battery status, an indication of signal propagation conditions, the time, the date, an icon indicating missed calls, etc.

There are many communication methods and protocols to bring a message to a portable communication device, e.g., SMS, e-mail, MMS etc. Some of these methods and protocols have notification features. For example, the receipt of an SMS may cause an icon or a user interface to appear on the display of the portable communication device.

However, such icons, information and visual indicators occupy valuable display area, and may sometimes be disturbing or even exceedingly annoying to the user, even to an extent where the readability of the display is jeopardized. A cramped display may cause severe visibility problems, especially when events occur simultaneously. A cramped display may cause misinterpretation or prevent the disabled or dyslectic user from using a portable communication device. Although the display area may be enlarged, the modest physical size of portable communication devices may limit the display size.

Therefore, in some instances, it may be undesirable with user devices, such as portable communication devices, that all notification and information may be visualized only on one single display with limited size.

A portable communication device may be a convenient tool for communication in situations where it may be possible to establish a wireless radio connection with a recipient. A portable communication device may have a modest size and may be carried consistently by the user. However, the user may find herself in situations where it is not possible to establish a connection with a portable communication device due to non existent radio signal coverage. Also, the telephone number of the intended recipient may be unknown, even though the intended recipient may be within sight. Such a situation may occur in an emergency situation when a user has lost her way at night time. In such a situation, the user may try to get the attention of, for example, an airborne rescue vehicle.

Thus, it may be a problem to use a portable communication device for visual signalling or messaging in areas out of radio signal coverage or when the recipient's communication coordinates, e.g., telephone number, may be unknown.

There may also be a problem displaying visual information on the display of a portable communication device to a large group of people, or to present visual information at a distance, due to the limited size of conventional display means on a portable communication device. Thus, the limited size of a conventional display of a portable communication device may be an obstacle to distant visual communication.

On travels, or when waiting at a reception at a dentist, for example, there may emerge a need for distraction and amusement. As an example there may be a requirement of playing an interpersonal game between a group of users. Existing technology solutions concerning games on portable communication devices has certain limits, especially when it comes to interpersonal games and games that could be played independently of radio propagation conditions.

Also, mass produced devices such as portable communication devices may be frequently produced in large series, causing a risk of confusing one user's portable communication device with another user's portable communication device. This may be a problem in particular, e.g., in a company providing one single model of portable communication device to all of their employees. Some user equipment, e.g., portable communication devices may be available in different colours or have interchangeable faceplates made of different coloured plastic. However, some users may consider these attempts to personalize or customize their portable communication device as being unsatisfactory or inadequate. Also, as the number of colours may be limited, the number of differentiation alternatives may also be limited. Additionally, many users enjoy customizing their user equipment such as portable communication devices; in particular if they may be advanced users that frequently use their user equipment. Thus, there may be a problem to personalize a user equipment, such as a portable communication device in order to distinguish it from other portable communication devices.

### SUMMARY

One or more embodiments disclosed herein may obviate some of the above mentioned problems associated with existing technology concerning displaying information by means of portable communication devices. One or more embodiments disclosed herein may provide a portable communication device with an illusive display on which information may be displayed in a visually appealing manner.

A first aspect embodiments disclosed herein may be directed towards a portable communication device that may include a motion detection unit adapted to measure movement related data. Also, the portable communication device may include a processing unit adapted to receive movement related data from the motion detection unit. Further, the portable communication device may include at least one light emitting element adapted to receive control signals from the processing unit.

The processing unit may be adapted to compute a lighting scheme, determining when to activate and when to deactivate the at least one light emitting element based on said movement related data. Further, the processing unit may be adapted to send control information according to the lighting scheme to the at least one light emitting element for activating and deactivating the at least one light emitting element. In that way, the at least one light emitting element, when the portable communication device is moved repetitively over a region of space, creates an illusive display. The illusive display may be adapted to illustrate information using persistence of vision of a viewer.

A second aspect may include the features of the first aspect, further and may further include a protrusive element situated on the same axis as the centre of gravity of the portable communication device.

A third aspect may include the features of the second aspect, wherein the protrusive element may include an antenna.

A fourth aspect may include the features of the first aspect, wherein the motion detection unit may be an accelerometer.

A fifth aspect may include the features of the first aspect, wherein the motion detection unit may be situated in one of the corners of the portable communication device.

A sixth aspect may include the features of the first aspect, wherein the at least one light emitting element may form an array of light emitting elements mounted on the portable communication device mainly perpendicular to the movement direction of the portable communication device.

A seventh aspect may include the features of the first aspect, wherein the at least one light emitting element may be adapted to emit a plurality of colours.

An eighth aspect may include the features of the first aspect wherein the at least one light emitting element may be a Light Emitting Diode (LED).

A ninth aspect may include the features of the first aspect wherein the portable communication device may include a memory unit.

A tenth aspect may be directed towards a method of creating an illusive display by using a wireless terminal. The portable communication device may include a motion detection unit, a processing unit and at least one light emitting element. The method of creating an illusive display further may include detecting the occurrence of a movement with the motion detection unit and sending the registrated movement related data to the processing unit.

The processing unit may compute when to activate and when to deactivate the at least one light emitting element. Then, the processing unit may send control information to the at least one light emitting element for activating and deactivating the at least one light emitting element, such that the at least one light emitting element, when the portable communication device is moved repetitively over a region of space, may create an illusive display adapted to present information using persistence of vision of a viewer.

An eleventh aspect may be directed towards a computer program comprising instruction sets for performing the method according to the tenth aspect.

A twelfth aspect may be directed towards an accessory to a portable communication device, wherein the accessory may be arranged to be attached to the portable communication device. The accessory may include a motion detection unit adapted to measure movement related data. The accessory also may include a processing unit adapted to receive movement related data from the motion detection unit. Also, the accessory may include at least one light emitting element adapted to receive control signals from the processing unit. The processing unit may be adapted to compute when to activate and when to deactivate the at least one light emitting element. The processing unit may also be adapted to send control information to the at least one light emitting element for activating and deactivating the at least one light emitting element, such that the at least one light emitting element, when the accessory is moved repetitively over a region of space, creates an illusive display adapted to present information using persistence of vision of a viewer.

A thirteenth aspect may include the features of the twelfth aspect and may further include a protrusive element situated on the same axis as the centre of gravity of the accessory when attached to a portable communication device.

A fourteenth aspect may include the features of the thirteenth aspect, wherein the protrusive element may include an antenna.

A fifteenth aspect may include the features of the twelfth aspect, wherein the motion detection unit may be an accelerometer.

A sixteenth aspect may include the features of the twelfth aspect, wherein the motion detection unit may be situated in one of the corners of the portable communication device.

A seventeenth aspect may include the features of the twelfth aspect, wherein the at least one light emitting element may form an array of light emitting elements and may be mounted on the accessory mainly perpendicular to the movement direction of the accessory.

An eighteenth aspect may include the features of the twelfth aspect, wherein the at least one light emitting element may be adapted to emit a plurality of colours.

A nineteenth aspect may include the features of the twelfth aspect, wherein the at least one light emitting element may be a Light Emitting Diode (LED).

A twentieth aspect may include the features of the twelfth aspect, wherein the accessory may include a memory unit.

In one or more embodiment disclosed herein, the visibility of information displayed on a portable communication device may be improved by presenting the information on an illusive display.

### BRIEF DESCRIPTION OF THE DRAWINGS

Embodiments disclosed herein will now be described more in detail in relation to the enclosed drawings, in which:

FIG. 1A is an exemplary schematic illustration of one embodiment of an illusive display created by spinning a portable communication device around like a spinning top.

FIG. 1B depicts an exemplary schematic illustration of a portable communication device, seen in profile, comprising an exemplary protrusive element.

FIG. 2 schematically depicts one embodiment of an exemplary illusive display created by moving a portable communication device back and forward over a region of space.

FIG. 3A is a schematic illustration of an exemplary portable communication device according to embodiments disclosed herein.

FIG. 3B is a schematic illustration of an exemplary lighting scheme, which may be computed by a processing unit in a portable communication device or accessory.

FIG. 4 is an exemplary flow chart illustrating a method in a portable communication device or in an accessory for creating an illusive display.

FIG. 5 is a schematic illustration one embodiment of an exemplary system with a portable communication device and an accessory, arranged to be attached to the portable communication device and to create an illusive display.

### DETAILED DESCRIPTION OF PREFERRED EMBODIMENTS

One embodiment is defined as a portable communication device, a method, a computer program and an accessory which may be put into practice in the embodiments described below.

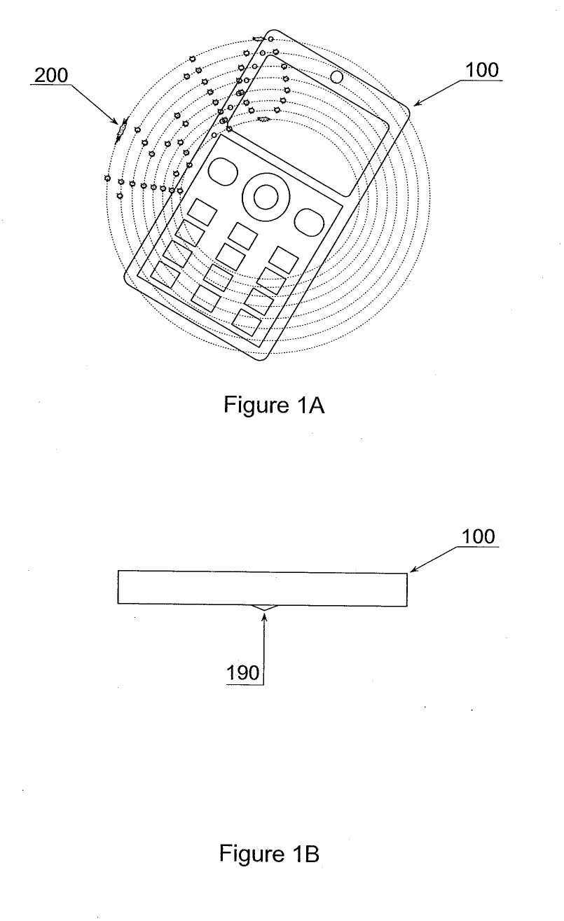

FIG. 1A is a exemplary illustration of an illusive display 200 created by spinning a portable communication device 100 around like a spinning top around, for example, a centre of gravity.

The illusive display 200 may be created by activating and deactivating light emitting elements while moving the portable communication device 100 repetitively over a region of space, thus creating a stroboscopic effect which, due to the persistence of vision, gives a viewer the illusion of an illusive display 200.

The spinning movement illustrated in FIG. 1A may be facilitated by letting the portable communication device 100 spin around a protrusive element 190 like a knob, point, nib, antenna, joint or similar element, situated, e.g., on the back side of the portable communication device 100. Such protrusive element 190 is depicted in FIG. 1B. The protrusive element 190 may be situated on the same axis as the centre of gravity of the portable communication device 100. The protrusive element 190 may in one embodiment include the logotype of the manufacturer of the portable communication device 100. Thus, it may be possible to spin the portable communication device 100 around like a like a spinning top.

The protrusive element 190 may in one embodiment include a ball bearing for improved functionality. The protrusive element 190 may in one embodiment be retractable into the body of the portable communication device 100 for improved portability.

In case the portable communication device 100 may be a foldable portable communication device such as a clam shell or foldable knife type cellular phone, the portable communication device 100 may be spun around a protrusive element 190 like the antenna knob, when the foldable cellular phone may be rotated in unfold position.

However, the portable communication device 100 may in one embodiment be spun in a yo-yo like manner, where the yoyo disk supports a freely pivoted mass about a low friction pivot such that as the portable communication device 100 spins in a yo-yo like manner, the mass then maintains a generally fixed geocentric orientation.

The repetitive movement made by the portable communication device 100 may by no means be limited to spinning but may be any kind of repetitive movement such as rotating, reciprocating, oscillating or vibrating the portable communication device 100. A rotating movement may be made by, for example, letting a user hold the portable communication device 100 in her hand and swing her arm around in a circular orbit. A repetitive movement may be made by, for example, letting a user moving the portable communication device 100 twirling in the air as a nightstick or a baton.

A rotating movement may, however, also be made by letting a user hold a strap attached to the portable communication device 100 in her hand and swing her arm around in a circular orbit like a sling, thus creating a prolonged orbit. A reciprocating movement may be made by letting a user hold a strap attached to the portable communication device 100 in her hand and swing her arm in a an at leas partly circular movement like a pendulum, thus creating a prolonged orbit.

In one embodiment, the portable communication device 100 may be adapted to be attached to a handbag, e.g., with a clip. The handbag may in turn be rotated in a circular or semi circular orbit, thus bringing the portable communication device 100 to generate an illusive display 200.

In one embodiment, creating a prolonged orbit may increase the size of the illusive display 200 accordingly. Thus, longer words or sentences, for example, may be displayed on the illusive display 200.

The strap may be attachable to the portable communication device 100, for example, on one of the short sides of the portable communication device 100, or at any other convenient location. The strap may also serve the purpose of carrying the portable communication device 100, e.g., around the neck of a user when the portable communication device 100 is not actively used.

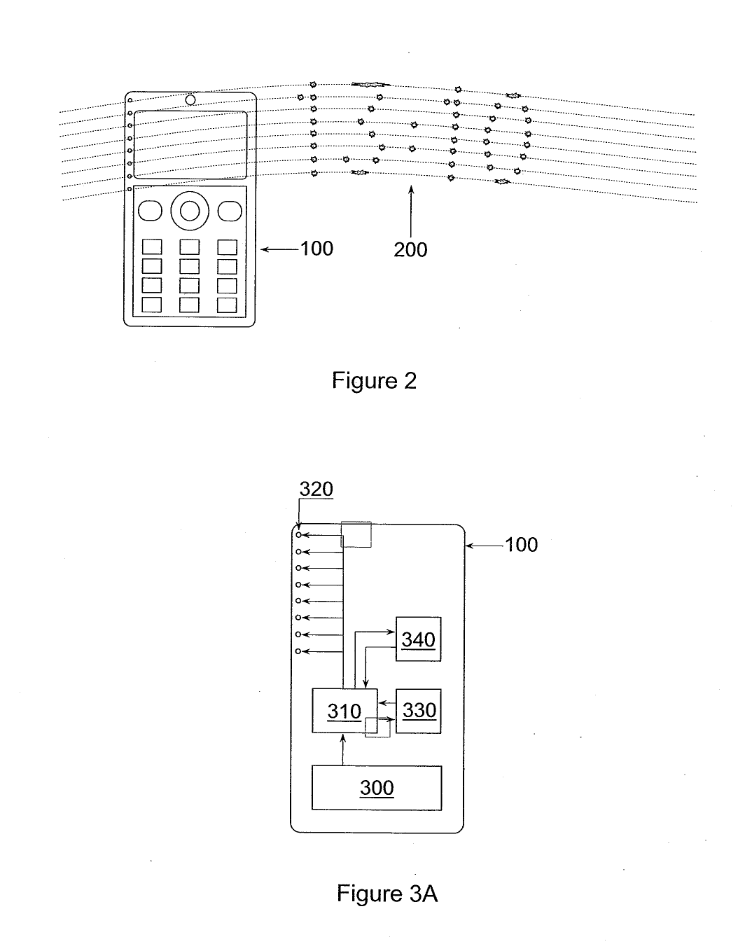

FIG. 2 depicts an illusive display 200 created by moving the portable communication device 100 in a reciprocating way, repetitively back and forward over a region of space.

The portable communication device 100, as herein described, may in one embodiment include a mobile station such as a mobile cellular radio telephone. The portable communication device 100 may, however, in one embodiment may include a Personal Digital Assistant (PDA), a laptop, a computer or any other kind of device adapted to communicate, such as notebook computers, walkie-talkies, hunting radios, baby monitors etc. The portable communication device 100 may in one embodiment be a foldable portable communication device such as a clam shell or foldable knife type cellular phone, e.g., a Sony Ericsson® W300i™.

However, in order to facilitate the comprehension process, and for the sole purpose of illustration, one embodiment wherein the portable communication device 100 may be embodied by a mobile cellular radiotelephone will now be described more in detail.

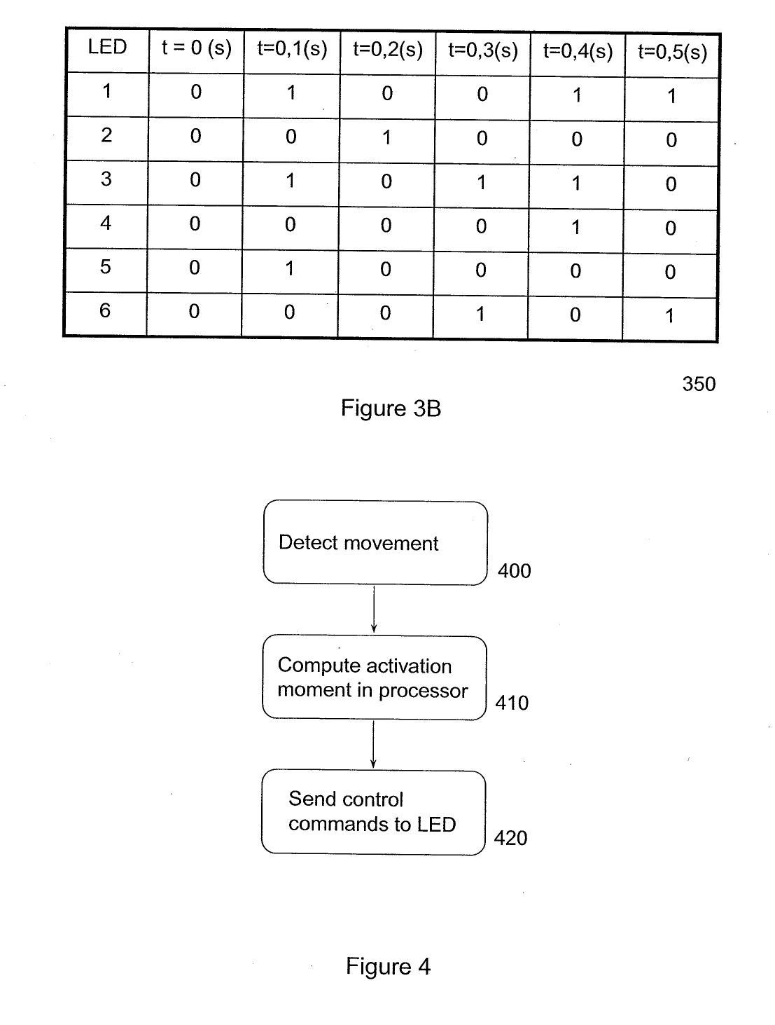

FIG. 3A depicts a portable communication device 100 comprising a motion detection unit 300 adapted to measure movement related data. The motion detection unit 300 may be an accelerometer but may as well be any kind of instrument adapted for measuring acceleration, detecting and measuring vibrations, or for measuring inclination or acceleration due to gravity or detecting and measuring speed or movement.

The motion detection unit 300, besides being adapted for the purpose of detecting movements for generating an illusive display 200, may be adapted also for other services that may be available on the portable communication device 100. Some examples of such other available services may include automatically aligning the screen depending on the direction the device is held. The motion detection unit 300 may also be adapted for image stabilization, provided the portable communication device 100 may include a camera, camcorder or similar function. The motion detection unit 300 may in such case also be used for anti-blur capturing. The motion detection unit 300 may also be adapted to determine the orientation of a photo being taken and for rotating the picture when viewing. The motion detection unit 300 may further also be adapted for the purpose of step counting. The motion detection unit 300 may also be used, for example, for the gesturing input to the portable communication device 100. The motion detection unit 300 may also be adapted to determine when a user has lifted the portable communication device 100 to the ear in order to make a telephone call or answer a telephone call, and then automatically activating the telephone function of the portable communication device 100.

The motion detection unit 300 may be situated at any position in the portable communication device 100. In one embodiment, the motion detection unit 300 may be placed at one or more of the four corners of the portable communication device 100. In another embodiment, the motion detection unit 300 may be placed at the periphery of the portable communication device 100. Placement of motion detection unit 300 away from the pivot point 190 (e.g., in a corner or at the periphery) may increase the velocity and/or acceleration of detection unit 300 when the motion detection unit 300 is rotated about pivot point 190 (as opposed to being placed at pivot point 190, for example). Increasing the velocity and/or acceleration allows for better detection of velocity and/or detection by detection unit 300.

Placing the motion detection unit 300 at a corner of the portable communication device 100 may allow for acceleration, speed and transported distance to be largest when the portable communication device 100 is spun or rotated. Thus, the motion detection unit 300 may react with an enhanced sensibility to a change in motion.

The portable communication device 100 also may include a processing unit 310 that may be adapted to receive movement related data from the motion detection unit 300. The processing unit 310 may include a Central Processing Unit (CPU), a microprocessor, a Peripheral Interface Controller (PIC) microcontroller or any other appropriate device adapted to interpret computer program instructions and processes data.

Further, the portable communication device 100 may also include at least one light emitting element 320 that may be adapted to receive control signals from the processing unit 310. The at least one light emitting element 320 may in one embodiment be mounted on the portable communication device 100 in a column or array, e.g., oen or more columns. In one embodiment the at least one light emitting element 320 may be mounted mainly perpendicular to the movement direction of the portable communication device 100.

The light emitting element 320 may be a Light-Emitting Diode (LED), an incandescent light bulb, an electric lamp, an arc lamp, a fluorescent light, a high-intensity discharge lamp, a halogen lamp, flashes or any other source capable of emitting photons, thus creating light, within or without the visible spectrum. The light emitting element 320 may in one embodiment be mounted in a column or array. The array of light emitting element 320 may include light emitting elements 320 of different types, e.g., LEDs with different colours. The array of light emitting element 320 may, however, in one embodiment include light emitting elements 320 of the same type.

The light emitting element 320 or array of light emitting elements may also be activated independently of the illusive display 200, e.g., when extra light may be needed. Such a situation may occur at night time, or when intending to take a photo in bad light conditions. In one embodiment, the light emitting element 320 may be activated when the portable communication device 100 comprising the motion detection unit 300 detects a movement or certain movement pattern, thus activating a flashlight function or stroboscopic flash function.

The light emitting element 320 or array of light emitting elements may also be activated independently of the illusive display 200 in order to present the signal propagation conditions, e.g., the signal strength or radio signal strength indication (RSSI), to a user. For example, the more light emitting elements 320 that may be activated, the better signal propagation conditions.

The light emitting element 320 or array of light emitting elements may also be activated independently of the illusive display 200 in order to present battery load conditions to a user. For example, the more light emitting elements 320 that may be activated, the greater the battery charge.

The light emitting element 320 or array of light emitting elements may also be activated independently of the illusive display 200 when the portable communication device 100 receives a telephone call or message.

The light emitting element 320 or array of light emitting elements may also be activated independently of the illusive display 200 in order to produce a walking light effect at an arbitrary moment.

FIG. 3B is an exemplary schematic illustration of a lighting scheme 350, which may be computed by the processing unit 310. The processing unit 310 may be adapted to compute lighting scheme 350 by determining when to activate and when to deactivate the at least one light emitting element 320 based on the movement related data. The processing unit 310 may also be adapted to send control information according to the lighting scheme 350, such as commands, to the at least one light emitting element 320 for activating and deactivating the at least one light emitting element 320, such that the at least one light emitting element 320, when the portable communication device 100 is moved over a region of space, creates illusive display 200 adapted to illustrate information using persistence of vision of a viewer. In one embodiment, the portable communications device 100 may be moved repeatedly over a region of space. In another embodiment, the portable communications device 100 may be moved once over a region of space.

Thus, an illusive display 200 may be created, which may be used to present visual information, e.g., letters, signs, images, words, sentences, light effects etc.

The processing unit 310 in the communication device 100 may receive movement related data from the motion detection unit 300. The movement related data may be instantaneous acceleration of the motion detection unit 300. Based on that movement related data, the processing unit 310 may further calculate the speed and or the angular velocity of the motion detection unit 300. As the distance between the motion detection unit 300 and the at least one light emitting element 320 may be previously known, the speed, angular velocity, position and/or translational movement for each individual light emitting element 320 may be computed, and the moment of activating and deactivating each individual light emitting element 320 may be determined. In one embodiment, the speed, angular velocity, position and/or translational movement for each individual light emitting element 320 may be determined by reading data from a look-up table stored in a memory (as opposed to or in addition to calculating these values).

Commands for activating and/or deactivating each light emitting element 320 may be based on the computed velocity of each light emitting element 320, which may be calculated (or otherwise determined using, for example, a loo-up table) by the processing unit 310. The time period for which each light emitting element 320 may be activated depends on the length of the segment that may be illustrated on the illusive display 200. As an example, the symbol “I” (e.g., a tall and narrow symbol) may cause a very short activation time for the array of light emitting elements 320 involved. On the other hand, the symbol “−” (e.g., a short and wide symbol) may be displayed by activating one light emitting element 320 for a longer time period (e.g., three times longer). In this example, a horizontal movement may be assumed. The movement (and possibly repetitive movement) may, however, be made in any other direction.

The lighting scheme 350 may be a scheme for activating and deactivating each individual light emitting element 320, in case the portable communication device 100 may include more than one light emitting element 320. In an iterative operation, the activation and deactivation times may be stored, e.g., in the lighting scheme 350 and may be used to adjust the period of the image or letter timing to display an information on an illusive display 200, during each cycle. Each change or stop in movement may in one embodiment be used to change the information to another word or image, such as, e.g., the time. In cyclical repetitively movements, the maximum acceleration or velocity may be used as a timing period reference causing information to be displayed on the illusive display 200 within one period or a predetermined period thereof.

Further, the portable communication device 100 may also include a memory unit 330. The memory unit 330 may be a primary storage memory unit such as a processor register, a cache memory, a Random Access Memory (RAM) or similar. The memory unit 330, however, in one embodiment may be a secondary memory unit such as a Read Only Memory (ROM), Electrically Erasable Programmable Read-Only Memory (EEPROM), programmable read-only memory (PROM) or erasable programmable read-only memory (EPROM) or a hard disk drive. The memory unit 330 may, however, in one embodiment be an off-line storage memory unit, a flash memory, a USB memory or a memory card. The memory unit 330 may in one embodiment be a Network-attached storage (NAS) or in fact any other appropriate medium such as a disk or a tape that can hold machine readable data.

The information presented on the illusive display 200 may be static information, such as a pre stored word or name which may be pre stored in the memory unit 330. The presented information may, however, alternatively be dynamic to its nature, such as presenting the clock or presenting, e.g., a sentence one word at a time, wherein each word may be pre stored in the memory unit 330.

The user may at an arbitrary moment of convenience modify the information he wants to present on the illusive display 200 by entering new information on the input terminal of the portable communication device 100 and storing the new information in the memory unit 330.

The presented information may be stationary, e.g., displayed on the same spot on the illusive display 200, when the portable communication device 100 may be moved in a repetitive way. The presented information may, however, in one embodiment be apparently moving or rotating, thus animating the displayed information.

Suppose, as a non limiting example, the portable communication device 100 may be brought into spinning such as illustrated by FIG. 1 with a rotational speed of 6 revolutions per second. If a light emitting element 320 is turned on 6 times per second, the light emitting element 320 will appear to be in the same position in its rotational cycle, so that it appears that the light emitting element 320 is stationary, e.g., on the same spot. Furthermore, at a frequency of 6 flashes per second, persistence of vision smoothes out the sequence of flashes so that the perceived image may be perceived as more or less continuous.

If however, as another example, the portable communication device 100 is brought into spinning such as illustrated by FIG. 1 with a rotational speed of 6 revolutions per second and the light emitting element 320 is turned on 5 times per second, each flash of the light emitting element 320 will be ignited at a slightly later part of its rotational cycle. Five flashes will occur before the light emitting element 320 appears in the same position again, and a viewer will perceive a series of images as if the light emitting element 320 may be rotating forwards once per second.

A similar but opposite effect may occur in another example where the portable communication device 100 may be brought into spinning such as illustrated by FIG. 1A with a rotational speed of 6 revolutions per second and the light emitting element 320 may be turned on 7 times per second.

Each flash of the light emitting element 320 ignites a little earlier in its rotational cycle and it may seem to a viewer that the light emitting element 320 may be slowly rotating backwards.

The information displayed on the illusive display 200 may be any kind of information, character, numeral, text, image, cartoon character or even graphic image for animation. The processing unit 310 may be programmed to cause animation of an image or other information in successive repeated movements of the portable communication device 100 as explained above.

The portable communication device 100 may also include a random number generator 340. The random number generator 340 may be a pseudo random number generator.

The portable communication device 100 may also be used in combination with the random generator 340 in order to realize a virtual dice. According to this embodiment of the portable communication device 100, the random generator 340 generates a number between 1 and 6 when a motion is detected by the motion detection unit 300 and light ignition commands may be sent to the light emitting devise 320, which may be ignited in order to present dice dots representing the numbers 1 to 6 on an illusive display 200. In another embodiment, the numbers 1 to 6 themselves may be displayed.

The portable communication device 100 may also in one embodiment be used to generate oracle answers, e.g., function as a decision generator/indicator for ambivalent decision makers etc.

In one embodiment, the illusive display 200 available on a portable communication device 100 may allow for most users of portable communication device 100 always, or rather frequently, to carry the portable communication device 100 with them.

A method in a portable communication device 100 for creating an illusive display 200 is depicted in the flow chart in FIG. 4. The method in a portable communication device 100 for creating an illusive display 200 may be realised in a number of blocks 400-420.

### Block 400

The method for creating an illusive display 200 by using a portable communication device 100 that may include a motion detection unit 300, a processing unit 310 and at least one light emitting element 320 may include detecting in block 400 the occurrence of a movement with the motion detection unit 300. The motion detection unit 300, which may be included in the portable communication device 100 may thus initiate the generation of an illusive display 200 when a movement, acceleration or speed above a certain threshold level is detected.

The generation of an illusive display 200 may also be initiated when a switch is turned on. The detected movement data may be registered by the motion detection unit 300. The movement related data may be sent in to the processing unit 310.

### Block 410

The processing unit 310 may computer in block 410 when to activate and when to deactivate at least one light emitting element 320. When the portable communication device 100 includes a plurality of light emitting elements 320, a calculation (or determination using, for example, a look-up table) may be made for each individual light emitting element 320.

### Block 420

Control information may be sent in block 420 from the processing unit 310 to the at least one light emitting element 320. The control information, e.g., commands, may be used for activating and deactivating the at least one light emitting element 320, such that the at least one light emitting element 320, when the portable communication device 100 may be moved, may create an illusive display 200 adapted to present information using persistence of vision of a viewer.

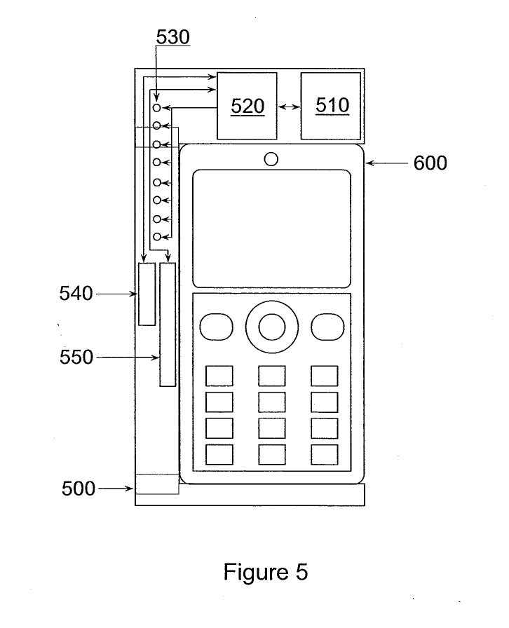

The method for creating an illusive display 200 by using a portable communication device 100 according to the present method can be implemented through one or more processors, such as the processor unit 310 in the portable communication device 100 depicted in FIG. 3 and the processor unit 520 in the adaptor unit 500 depicted in FIG. 5, together with computer program code for performing the functions of the method. The program code mentioned above may also be provided as a computer program product, for instance in the form of a data carrier carrying computer program code for performing the method according to embodiments disclosed herein when being loaded into a processor unit 310; 520. The data carrier may be a CD ROM disc, a memory stick, or any other appropriate medium such as a disk or tape that can hold machine readable data. The computer program code can furthermore be provided as pure program code on a server and downloaded to the portable communication device 100 and/or adaptor unit 500 remotely.

Thus, a computer program comprising instruction sets for performing the method according to blocks 400-420 may be used for implementing the previously described method.

There may emerge a need of an illusive display 200 also among users of portable communication devices 600 not being adapted to generate an illusive display 200. Such desire may be satisfied by providing an accessory 500, the accessory 500 may be arranged to be attached to a portable communication device 600. Such an accessory 500 adapted to be attached to a portable communication device 600 may be depicted in FIG. 5. The attachment may be made, e.g., by snapping, sticking, pinning, bolting, pinching, strapping, clipping, pegging, screwing, hooking, hinging, taping, stitching, fastening, tacking, tying, cramping, gluing, velcroing, or in any other convenient way, permanently or temporarily attaching the portable communication device 600 into the accessory 500. The accessory 500 and a portable communication device 600 thus forming a system for generating an illusive display 200.

The accessory 500 may in one embodiment be produced in a plastic material e.g. a synthetic or semi synthetic polymerization material, e.g., polyvinyl chloride, polyethylene, polymethyl methacrylate, acrylics, silicones, polyurethanes, polypropylene, polystyrene, etc. However, the accessory 500 may be produced in, for example, metal, wood, rubber or any other convenient material.

The accessory 500 may include a motion detection unit 510, adapted to measure movement related data. The motion detection unit 510 may be an accelerometer but may as well be any kind of instrument adapted for measuring acceleration, detecting and measuring vibrations, or for measuring inclination or acceleration due to gravity or detecting and measuring speed or movement.

The accessory 500 may also include a processing unit 520 adapted to receive movement related data from the motion detection unit 510. Further, the accessory 500 may also include at least one light emitting element 530 adapted to receive control signals from the processing unit 520.

The light emitting element 530 may be a Light-Emitting Diode (LED), an incandescent light bulb, an electric lamp, an arc lamp, a fluorescent light, a high-intensity discharge lamp, a halogen lamp, flashes or any other convenient source capable of emitting photons, thus creating an artificial light, within or without the visible spectrum. The light emitting element 530 may further in one embodiment be mounted in a column or array, e.g., perpendicular or mainly perpendicular to the movement orbit when generating an illusive display 200. The array of light emitting element 530 may include light emitting elements 530 of different types, e.g., LEDs in different colours. The array of light emitting element 530 may, however, in one embodiment include light emitting elements 530 of the same type.

The processing unit 520, comprised in the accessory 500, may be adapted to compute when to activate and when to deactivate the at least one light emitting element 530. The processing unit 520 may be a Central Processing Unit (CPU), a microprocessor or any other appropriate device adapted to interpret computer program instructions and processes data.

The processing unit 520 may also be adapted to send control information, e.g., commands, to the at least one light emitting element 530 for activating and deactivating the at least one light emitting element 530, such that the at least one light emitting element 530, when the system may be moved repetitively over a region of space, may create an illusive display 200 adapted to present information using persistence of vision of a viewer.

The accessory 500 may include a protrusive element such as a knob, point, nib, antenna, joint or similar element, situated, e.g., on the back side of the accessory 500. Thus, a spinning movement of the accessory 500 with the attached portable communication device 600 may be facilitated. The protrusive element 190 may in one embodiment include the logotype of the manufacturer of the portable communication device 100; 600 and /or the logotype of the manufacturer of the accessory 500. The protrusive element may be situated on the same axis as the centre of gravity of the accessory 500 when a portable communication device 600 is attached to the accessory 500.

The protrusive element 190 may in one embodiment include a ball bearing for improved functionality. The protrusive element 190 may in one embodiment be retractable into the body of the accessory 500 for improved portability.

In one embodiment, due to the iterative measuring of changes in movement and recalculation of activation and deactivation periods for the light emitting devices 320; 530, the portable communication device 100 and/or the accessory 500 may automatically sense changes in the period or cycle time of the motion for synchronizing information on the illusive display 200 in variable rate repetitive motion environments.

Further, the accessory 500 may also include a memory unit 540. The memory unit 540 may be a primary storage memory unit such as a processor register, a cache memory, a Random Access Memory (RAM) or similar. The memory unit 540 may, however, in one embodiment be a secondary memory unit such as a Read Only Memory (ROM), Electrically Erasable Programmable Read-Only Memory (EEPROM), programmable read-only memory (PROM) or erasable programmable read-only memory (EPROM) or a hard disk drive. The memory unit 540 may, however, in one embodiment be an off-line storage memory unit, a flash memory, a USB memory or a memory card. The memory unit 540 may in one embodiment include a Network-attached storage (NAS) or in fact any other appropriate medium such as a disk or a tape that can hold machine readable data.

The information presented on the illusive display 200 may be static information, such as a pre stored word or name that may be pre stored in the memory unit 540. The presented information may, however, alternatively be dynamic to its nature, such as presenting the clock or presenting, e.g., a sentence one word at a time, wherein each word may be pre stored in the memory unit 540.

The accessory 500 may also include a random number generator 550. The random number generator 550 may be a pseudo random number generator.

The accessory 500 may also be used in combination with the random generator 550 in order to realize a virtual dice. According to this embodiment of the accessory 500, the random generator 550 generates a number between 1 and 6 when a motion may be detected by the motion detection unit 510 and light ignition commands may be sent to the light emitting devise 530, which may be ignited in order to present dice dots representing the numbers 1 to 6 on the illusive display 200.

The accessory 500 may also in one embodiment be used to generate oracle answers, e.g., function as a decision generator/indicator for ambivalent decision makers etc.

Thus, an illusive display 200 may be created, which may be used to present visual information such as letters, a pre stored piece of information such as the name of the owner of the mobile terminal 100; 600 or of the system with the accessory 500, the clock, the date, the day of the week, the number of the week, the month, the year and similar information. The presented visual information may also include the battery status, status report indicating the signal propagation conditions, an icon indicating missed calls and messages, and similar.

The battery status may be indicated by lightening light emitting elements 320; 530 in different colours when generating an illusive display according to the present method, e.g., dark green light may indicate full battery charge, light green light may indicate medium battery charge, yellow light may indicate low battery charge and red light may indicate that the battery may be almost completely discharged.

The visibility of the display of communication device 100 may be improved by presenting some information on an illusive display 200, as the need of squeezing in information on the limited area of a non illusive display may be reduced.

In one embodiment, the present portable communication device 100 or the accessory 500 may allow for certain selected information such as the time or battery status may be displayed with enhanced readability on an illusive display 200, using bigger letters than may be possible to use on the ordinary display of a portable communication device 100 or 600, thus facilitating the reading process for disabled, aged, dyslectic and/or near-sighted user.

The present portable communication device 100 or the accessory 500 may allow for personalization by pre-storing, for example, the owner's name, the name of the owner's pet, the name of the owner's favorite ice hockey team etc, on an illusive display 200.

The portable communication device 100 or the accessory 500 may in one embodiment be used to communicate a visual message to a recipient at a distance but within sight, whose telephone number may be unknown or who may be unreachable due to bad radio propagation conditions. An example may be to display the word “Help!” on the illusive display 200 in an emergency situation when a user has lost her way in a savage surrounding at night time and to try get to the attention of, for example, an airborne rescue vehicle.

Especially under such circumstances, one embodiment may facilitate the use of the illusive display because the user of a portable communication device 100; 600 may normally carry the portable communication device 100; 600 with her all the time or at least rather frequently.

The portable communication device 100 or the accessory 500 may in one embodiment be used to communicate a visual message to a recipient in an ambiance where the telephone function of a portable communication device 100 may not be feasible or allowed, e.g., to signal the users position in a sports arena to a recipient by presenting, e.g., the recipients name on the illusive display 200.

The portable communication device 100 or the accessory 500 may in one embodiment be used to communicate a visual message to a recipient with an unknown telephone number, such as emitting a visual comment on the illusive display 200 to the driver of a vehicle in a traffic situation. Such visual communication may in one embodiment include less favourable remarks and even not quite so flattering comments or illustrated dubious gestures.

The portable communication device 100 or the accessory 500 may, in one embodiment, be used to communicate a visual message on the illusive display 200 in dialog with a recipient at a distance but within sight, who also has access to a portable communication device 100 or an accessory 500 capable of generating an illusive display 200.

One embodiment may allow the portable communication device 100 or the accessory 500 to be used for visual communication on an illusive display 200 in accordance with at least some of the described embodiments free of charge, without need of a subscription to a service provider.

The portable communication device 100 or the accessory 500 may in one embodiment be used as a party booster, providing coloured and/or information such as text, images or stereoscopically blinking flashes on the illusive display 200. In one embodiment, a music player, such as an MP3 player, may be included in the portable communication device 100 or in the portable communication device 600 or in the accessory 500, and activated simultaneously with the generation of the illusive display 200 when the portable communication device 100 or the accessory 500 is set into party booster mode.

The portable communication device 100 or the accessory 500 may in one embodiment be used by, for example, a museum guide for assembling an audience group and to communicate a visual message on the illusive display 200 to the audience in a museum or on a guided tour at an arbitrary location such as a city guidance tour. The visual message on the illusive display 200 may in one embodiment include signs from Asiatic alphabets, e.g., Chinese or Japanese.

The portable communication device 100 or accessory 500 may in one embodiment provide a game facility by, for example, by counting the number of revolutions a user may spin the portable communication device 100 or system comprising the accessory 500 and letting the light emitting elements 320; 530 change colours for every ten revolutions. Thus, making it possible to compete, for example, who could make the largest number of revolutions etc.

The portable communication device 100 or the accessory 500 may in one embodiment be used as a spirit level (e.g., a carpenter's level), measuring the inclination of the portable communication device 100 or system comprising the accessory 500 by using measurements made by the motion detection unit 300, measuring acceleration due to gravity.

The portable communication device 100 or the accessory 500 may in one embodiment be adapted to be attached to the spoke of a bicycle wheel, emitting light or some informative message on an illusive display 200, thus serving as a traffic security device as the visibility of the biker and the bicycle to other trafficants may be improved, especially in obscure lightening.

The portable communication device 100 or the accessory 500 may in one embodiment be adapted to be attached to the spoke of a bicycle wheel, emitting light according to a colour scheme according to the velocity of the bicycle, e.g., blue light for less than 5 km/hour, green light for 5-10 km/hour, yellow light for 10-20 km/hour, orange light for 20-30 km/hour, red light for 30-40 km/hour, strobing red light for 40-50 km/hour etc. The portable communication device 100 or the accessory 500 may thus serve as a speedometer and/or a physical training enhancement and stimulation device.

The portable communication device 100 or the accessory 500 may in one embodiment be adapted to be attached to the arm or hand of a pedestrian, emitting light or some informative message on an illusive display 200, thus serving as a traffic security device as the visibility of the enlightened pedestrian to other trafficants may be improved, especially in obscure lightening.

The portable communication device 100 or the accessory 500 may in one embodiment be adapted to be attached to the arm or hand of a pedestrian, emitting light according to a colour scheme according to the velocity of the pedestrian, e.g., blue light for less than 2 km/hour, green light for 2-5 km/hour, yellow light for 5-10 km/hour, orange light for 10-20 km/hour, red light for 20-30 km/hour, strobing red light for 30-40 km/hour etc. The portable communication device 100 or the accessory 500 may thus serve as a speedometer and/or a physical training enhancement and stimulation device.

While the portable communication device 100 and method of generating an illusive display 200, computer program and accessory 500 described in this document may be susceptible to various modifications and alternative forms, specific embodiments thereof may be shown by way of example in the drawings and may be herein described in detail. It should be understood, however, that there may be no intent to limit the present portable communication device 100, method of generating an illusive display 200, computer program or accessory 500 to any of the particular forms disclosed, but on the contrary, the present portable communication device 100 and method of generating an illusive display 200 may be to cover all modifications, equivalents, and alternatives falling within the spirit and scope of the portable communication device 100, method of generating an illusive display 200, computer program and accessory 500 as defined by the claims.

Like reference numbers signify like elements throughout the description of the figures. As used herein, the singular forms “a,” “an,” and “the” are intended to include the plural forms as well, unless expressly stated otherwise. It should be further understood that the terms “include,” “includes,” “comprise,” “comprises,” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present.

Furthermore, “connected” or “coupled” as used herein may include wirelessly connected or coupled. As used herein, the term “and/or” includes any and all combinations of one or more of the associated listed items.

Unless otherwise defined, all terms including technical and scientific terms used herein have the same meaning as commonly understood by one of ordinary skill in the art to which the portable communication device 100, method of generating an illusive display 200, computer program and/or accessory 500 belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

1. A portable communication device comprising:
a motion detection unit adapted to measure movement related data,
a processing unit adapted to receive the movement related data from the motion detection unit, and
at least one light emitting element adapted to receive control signals from the processing unit, wherein:
the processing unit is adapted to compute a lighting scheme that determines when to activate and when to deactivate the at least one light emitting element based on said movement related data, and to send control information according to said lighting scheme to the at least one light emitting element for activating and deactivating the at least one light emitting element, such that the at least one light emitting element, when the portable communication device is moved repetitively over a region of space, creates an illusive display adapted to convey information using persistence of vision of a viewer.

2. The portable communication device according to claim 1, further comprising a protrusive element situated on the same axis as the centre of gravity of the portable communication device.

3. The portable communication device according to claim 2, wherein the protrusive element comprises an antenna.

4. The portable communication device according to claim 1, wherein the motion detection unit is an accelerometer.

5. The portable communication device according to claim 1 wherein the motion detection unit is situated along the periphery or in one of the corners of the portable communication device.

6. The portable communication device according to claim 1 wherein the at least one light emitting element form an array of light emitting elements mounted on the portable communication device mainly perpendicular to the movement direction of the portable communication device.

7. The portable communication device according to claim 1 wherein the at least one light emitting element is adapted to emit a plurality of colours.

8. The portable communication device according to claim 1 wherein the at least one light emitting element includes a Light Emitting Diode (LED).

9. A method for creating an illusive display by using a portable communication device comprising a motion detection unit, a processing unit and at least one light emitting element comprising:
detecting the occurrence of a movement of the portable communication device,
determining a lighting scheme, based on the detected movement, that includes information for when to activate and when to deactivate the at least one light emitting element,
sending control information to the at least one light emitting element according to said lighting scheme for activating and deactivating the at least one light emitting element, such that the at least one light emitting element, when the portable communication device is moved repetitively over a region of space, creates an illusive display adapted to present information using persistence of vision of a viewer.

10. The method according to claim 9, further comprising rotating the portable communication device about a centre of gravity of the portable communication device.

11. The method according to claim 9, wherein detecting the occurrence of a movement includes detecting the acceleration of the portable communication device.

12. The method according to claim 9, wherein detecting the occurrence of the movement includes detecting an occurrence of the movement at the periphery or at one of the corners of the portable communication device.

13. The method according to claim 9, wherein the at least one light emitting element form an array of light emitting elements, the method further comprising moving the portable communication device mainly in a perpendicular direction to the array of light emitting elements.

14. The method according to claim 9, wherein the at least one light emitting element includes a Light Emitting Diode (LED).

15. An accessory arranged to be attached to a portable communication device, the accessory comprising:
a motion detection unit adapted to measure movement related data,
a processing unit adapted to receive movement related data from the motion detection unit, and
at least one light emitting element adapted to receive control signals from the processing unit, wherein
the processing unit is adapted to compute a lighting scheme determining when to activate and when to deactivate the at least one light emitting element based on said movement related data, and to send control information according to said lighting scheme to the at least one light emitting element for activating and deactivating the at least one light emitting element, such that the at least one light emitting element creates an illusive display adapted to convey information using persistence of vision of a viewer when the accessory is moved repetitively over a region of space.

16. The accessory according to claim 15, further comprising a protrusive element situated on the same axis as the centre of gravity of the accessory when attached to a portable communication device.

17. An accessory according to claim 16, wherein the protrusive element comprises an antenna.

18. The accessory according to claim 15, wherein the motion detection unit is an accelerometer.

19. The accessory according to claim 15, wherein the motion detection unit is situated along the periphery or in one of the corners of the portable communication device.

20. The accessory according to claim 15, wherein the at least one light emitting element form an array of light emitting elements mounted on the accessory mainly perpendicular to the movement direction of the accessory.

21. The accessory according to claim 15, wherein the at least one light emitting element includes a Light Emitting Diode (LED).

22. A computer-readable medium including instructions executable by at least one processor, the computer-readable medium comprising:
one or more instructions to detect the occurrence of a movement of a portable communication device comprising at least one light emitting diode,
one or more instructions to determine a lighting scheme, based on the detected movement, that includes information for when to activate and when to deactivate the at least one light emitting diode,
one or more instructions to send control information to the at least one light emitting diode according to said lighting scheme for activating and deactivating the at least one light emitting diode, such that the at least one light emitting diode, when the portable communication device is moved over a region of space, creates an illusive display adapted to present information using persistence of vision of a viewer.
